(19) United States
(12) Patent Application Publication
(10) Pub. No.: US 2007/0061400 A1
(43) Pub. Date: Mar. 15, 2007

(54) Methods for organizing emails in folders

(75) Inventor: Robert R. Parsons, Scottsdale, AZ (US)

Correspondence Address: GO DADDY GROUP, INC., 14455 NORTH HAYDEN ROAD, SUITE 219, SCOTTSDALE, AZ, 85260, US

(73) Assignee: The Go Daddy Group, Inc.

(21) Appl. No.: 11/225,936

(22) Filed: Sep. 13, 2005

(51) Int. Cl. G06F 15/16

(52) U.S. Cl. 709/206

(57) ABSTRACT

The present invention provides improved methods for organizing emails in folders. An Email User may create an original email or a reply email. One or more folders may be chosen for storing the email. The folder(s) are preferably chosen by the Email User from a drop-down menu. In other embodiments, the folder(s) may be chosen by an email system or a Client-based email application based on the recipients, sender or subject matter of the emails. For reply emails, an option may be provided for storing either the original email or the reply email (which will typically include the text of the original email) in the chosen folder(s). The Email User may then select a Send/File option thereby causing the email to be transmitted to the recipient(s), stored in the chosen folder(s), and preferably blocked or deleted from the default sent email folder.

### FIELD OF THE INVENTION

The invention relates to improved methods for organizing emails in folders.

### BACKGROUND OF THE INVENTION

The Internet is a worldwide computer network arranged to allow the easy and robust exchange of information between computer users. Hundreds of millions of people around the world have access to computers connected to the Internet. One of the most popular uses of the Internet is the transmission of electronic messages (emails) between Email Users.

Email may contain, for example, text, images, links, and attachments. Email is one of the most widely used methods of communication over the Internet due to the variety of data that may be transmitted, large number of available recipients, speed, low cost and convenience.

Emails may be sent, for example, between friends, family members, coworkers, customers and businesses thereby substituting for traditional letters and office correspondences in many situations. Emails travel across the Internet, typically passing from email server to email server, at amazing speeds achievable only by electronic data. The Internet provides the ability to send an email anywhere in the world, often in less than a few seconds. Delivery times are continually being reduced as the Internet's ability to transfer electronic data improves.

FIG. 1 is a simplified diagram illustrating two types of email systems 100, 120. In a first type of email system 100, an Email User 104 may send and receive email messages via a Computer Network 150 (typically the Internet) using a Web-based email server 101. The Web-based email server 101 may include a Website (not shown) that Email Users 104 may access to create a Web-based email account 102, read and send emails, and organize emails in folders 103. A log-in process is typically used to authenticate the Email User 104, i.e. by asking for a user ID and password.

One of the advantages of Web-based email systems 100 is that email messages may be easily transmitted and accessed from just about any computer that has a browser 105 and an Internet connection. Typically, no other special software or setup is required to access a Web-based email system 100. The advantage of ubiquitous access is becoming more pronounced as Email Users want to easily access their emails from an increasing number of locations, e.g. work, home, various travel destinations, etc. An exemplary Web-based email account 102 is offered by GoDaddy.com at www.GoDaddy.com.

In a second type of email system 120 an Email User 124 may send and receive email messages via a Computer Network 150 (also typically the Internet) using a Client-based email server 121. The Email User 124 may create a Client-based email account 122 with the Client-based email server 121 using a Client-based email application 125, such as OUTLOOK® produced by Microsoft Corporation or LOTUS NOTES® produced by IBM. While Client-based email accounts 122 may include folders 123 to store emails, most emails for Client-based email systems 120 are typically transmitted to, and then saved in, folders associated with a Client-based email application 125. The emails may be organized in the folders 126 via the Client-based email application 125.

For Web-based 102 and Client-based email accounts 122, the volume of emails sent, received and replied to can grow very large. The task of organizing the emails by the Email User 104, 124 can become quite burdensome and the amount of memory required to store all the emails can become quite expensive. One particular problem is that the sent email folder (which is widely used by email systems 100, 120 and Client-based email applications 125 to store all transmitted emails) rapidly fills up and quickly becomes disorganized. This catch-all folder may require a significant amount of memory to hold all the transmitted emails and lacks any organized structure making it very difficult to find any particular email.

It may be desirable to organize emails (by placing them in appropriately named folders) according to their Recipients 130, topic, or for reply emails, according to the previous sender. While the task of moving any single email to a desired folder 103, 123, or 126 may be fairly trivial, the shear volume of emails received and sent by many Email Users 104, 124 means any improvements to the overall method used to organize emails will be a significant improvement. New methods are therefore needed to improve and streamline the ability of Email Users 104, 124 to organize their emails in folders 103, 123, or 126 and minimize the memory requirements of the sent email folder.

### SUMMARY OF THE INVENTION

The present invention provides improved methods for organizing emails in folders. An Email User may create either an original email or a reply email. One or more folders may be chosen for storing the email. The folder(s) are preferably chosen from a drop-down menu by the Email User.

In other embodiments, the folder(s) may be chosen by an email system or a Client-based email application based on the recipients, sender or subject matter of the emails.

For reply emails, an option may be provided for storing in the chosen folder(s) either the original email or the reply email (which will typically include the text of the original email).

The Email User may then select a Send/File option thereby causing the email to be transmitted to the recipient(s), stored in the chosen folder(s), and preferably blocked or deleted from the default sent email folder.

Additional advantages and aspects of the present invention will become apparent in the following detailed description of the invention and the claims.

### BRIEF DESCRIPTION OF THE DRAWINGS

FIG. 1 is a block diagram illustrating the relationships of elements and the communication path ways in an example embodiment of the invention.

FIG. 2 is an illustration of a drafted reply email according to an exemplary embodiment of the invention.

FIG. 3 is a flowchart illustrating an exemplary method of practicing the invention.

FIG. 4 is a flowchart illustrating another exemplary method of practicing the invention.

### DETAILED DESCRIPTION OF THE PREFERRED EMBODIMENTS

The present invention will now be discussed in detail with regard to the attached drawing figures that were briefly described above. In the following description, numerous specific details are set forth illustrating Applicant's best mode for practicing the invention and for enabling one of ordinary skill in the art to make and use the invention. It will be obvious, however, to one skilled in the art that the present invention may be practiced without many of these specific details. In other instances, well-known machines and process steps have not been described in particular detail in order to avoid unnecessarily obscuring the present invention. Unless otherwise indicated, like parts and processes are referred to with like reference numerals.

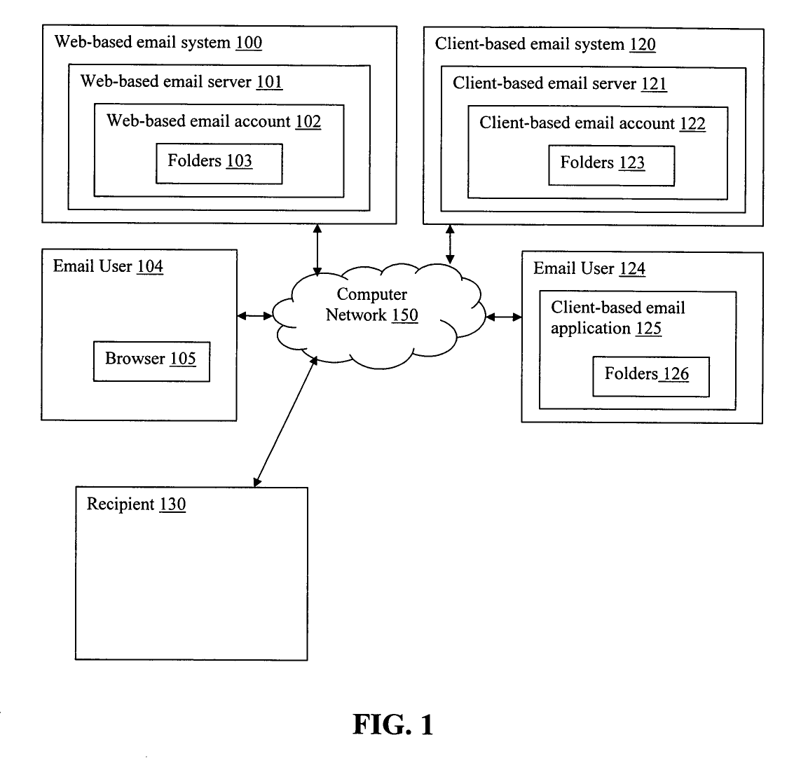

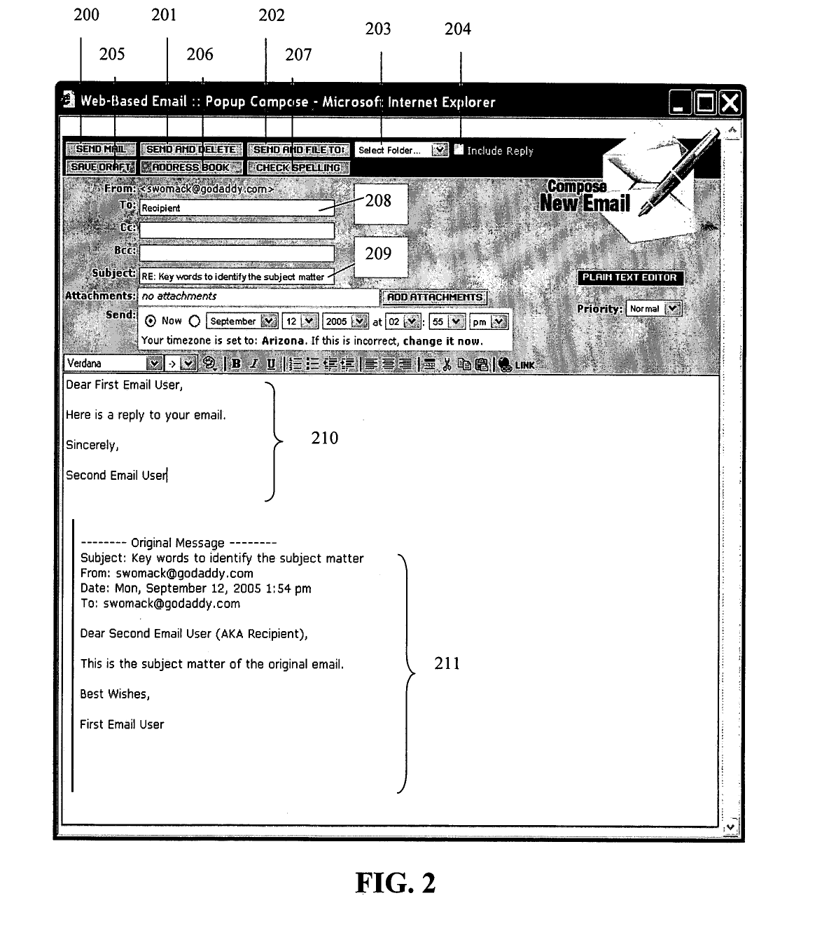

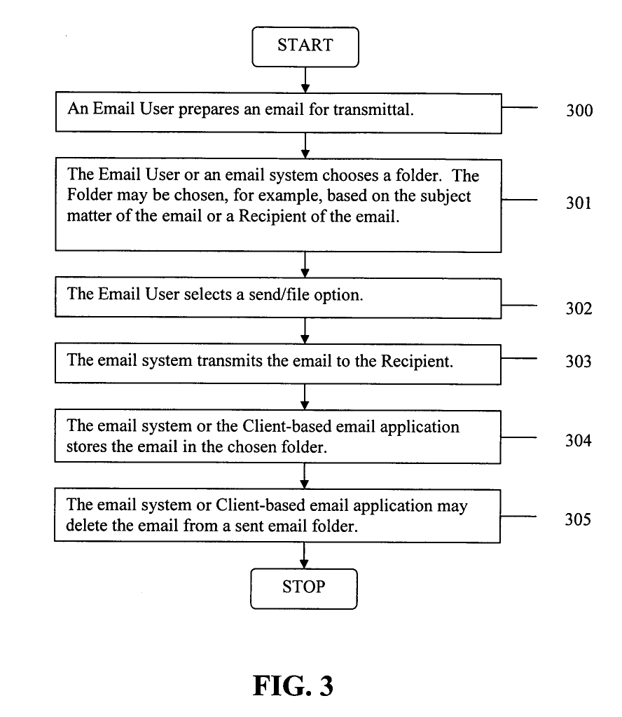

The present invention is designed to facilitate the organization and storage of emails in various folders or subfolders (hereafter folders) in an email system or a Client-based email application. An exemplary method of practicing the invention will now be discussed with reference to FIG. 1, FIG. 2, and FIG. 3. An Email User may create an email for transmittal. (Step 300) The Email User may use a Web-based email account 102 or a Client-based email application 125 to draft and create the email.

FIG. 2 illustrates a computer interface for drafting a reply email that shares many of the same elements as a computer interface for drafting an original email and thus will be used to serve as an illustration for this embodiment with that limitation in mind. The header information and drafted text in the original email are shown at 211. The Email User 104, 124 may select a folder 103, 123, or 126 from a drop-down menu of folders 203. The Email User 104, 124 may then choose one or more of the listed folders in the drop-down menu. (Step 301)

An alternative method for choosing one or more folders is to allow the email system 100, 120 or Client-based email application 125 to automatically, i.e. via software, choose the folder(s). The folder(s) may be chosen based on the Recipient(s) 208 of the email or the subject matter of the email. The subject matter may be determined by a search for key words in the Subject line 209 or the body of the email 210 or 211. (Step 301)

Once the folder(s) has been chosen (and of course all the Recipients selected, desired text drafted, attachments added and Subject line entered), the Email User may press a send/file button 202. (Step 302) The email may then be transmitted to the selected Recipient(s) 208. (Step 303) The email system 100, 120 or Client-based email application 125 may store the email in the chosen folder(s). (Step 304) Advantageously, if the send/file button 200 was selected, the email may be deleted from a sent email folder or simply never stored in the sent email folder. (Step 305) This will reduce the amount of storage necessary for storing all the transmitted emails by removing an unnecessary duplicate of the email that is now properly stored in a chosen folder 103, 123, or 126. This also simplifies the email process for the Email User 104, 124 since the Email User 104, 124 no longer has to delete the transmitted email from the sent email folder.

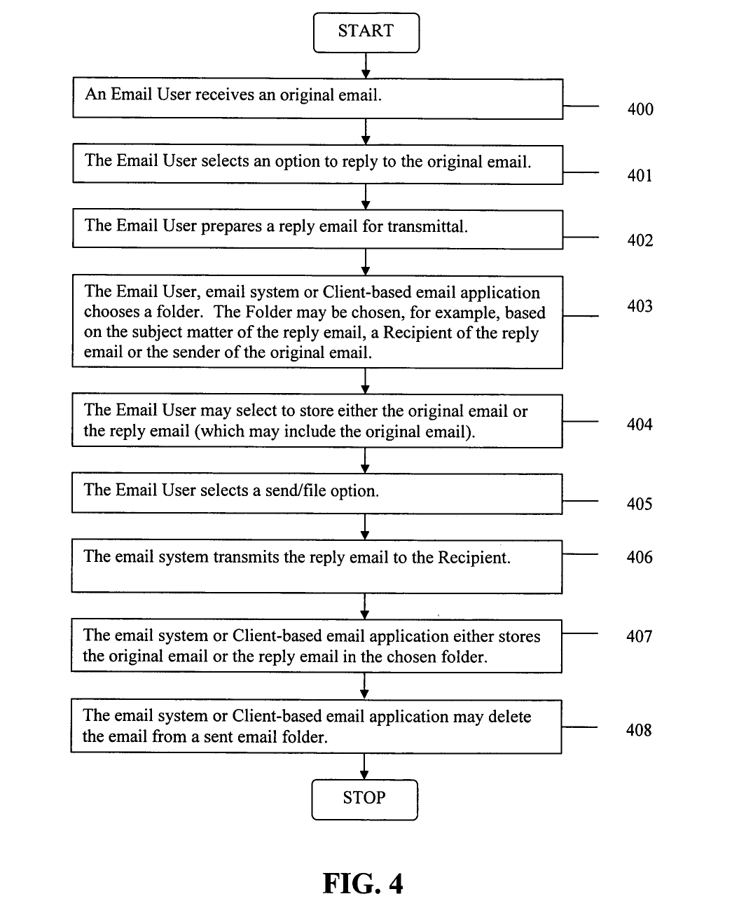

Another embodiment of the invention will now be discussed with reference to FIG. 1, FIG. 2, and FIG. 4. In this embodiment the Email User 104, 124 receives an original email and selects an option to reply to the original email. (Steps 400 and 401) The Email User 104, 124 may create a reply email via an email system 100, 120 or a Client-based email application 125. (Step 402) An illustrative reply email and preferred webpage buttons/functions are illustrated in FIG. 2.

In a preferred embodiment, the Email User 104, 124 may be provided several options in handling the email. The Email User 104, 124 may have the option of sending the email by pressing the button at 200. This option may store the transmitted email in a default sent email folder. The Email User 104, 124 may also have the option of sending and deleting the email by pressing the button at 201. This option allows the Email User 104, 124 to efficiently reduce the amount of saved emails in the sent email folder.

The Email User 104, 124 may select one or more folders 103, 123, or 126 from a drop-down menu of folders at 203. (Step 403) In other embodiments, a list of folders that may be chosen may always be visible to the Email User 104,124. In still other embodiments, a pop-up screen may appear displaying a list of folders that may be chosen by the Email User 104, 124. Those skilled in the art will recognize that there are many different ways for an Email User 104, 124 to choose one or more folders via a computer interface.

An alternative method for choosing one or more folders is to allow the email system 100, 120 or Client-based email application 125 to automatically, i.e. via software, choose the folder(s). The folder(s) may be chosen based on the original or previous sender, the Recipient(s) 208 and/or the subject matter of the email. The subject matter may be determined by a search for key words in the Subject line 209 or the body of the email 210 and 211. (Step 403) Each folder may have one or more key words associated with the folder which, when found in an email or a reply email, cause the email to be stored in the chosen folder(s).

An option may also be included at 204 for selecting between storing just the original email or the reply email (which preferably includes the original email text) in the chosen folder(s). (Step 404) Alternatively, the email system 100, 120 may default to storing the original email or may default to storing the reply email. In addition, other web pages may be provided for allowing the Email User to alter the defaults of storing either the original email or the reply email in the chosen folder(s).

The Email User 104, 124 may also be provided at 205 with an option of saving a draft of the email which may be recalled at a later date for continued drafting/transmitting. The Email User 104, 124 may also be able to add and edit an address book by selecting the option provided at 206. The Email User 104, 124 may also be provided with an ability to spell check their email by selecting the option provided at 207. Options may also be provided on other web pages for selecting whether emails should be spell checked prior to being transmitted.

Once the folder(s) has been chosen (and of course all the Recipients selected, desired text drafted, attachments added and Subject line entered), the Email User may press a send/file button 202. (Step 405) The email may then be transmitted to the selected Recipient(s) 208. (Step 406) The email system 100, 120 or Client-based email application 125 may store either the original email or the reply email in the chosen folder(s). (Step 407) Advantageously, if the send/file button 200 was selected, the email may be deleted from a sent email folder or simply never stored in the sent email folder. (Step 408) This will reduce the amount of storage necessary for storing all the transmitted emails by removing an unnecessary duplicate of the email that is now properly stored in a desired folder 103, 123, or 126. This also simplifies the email process for the Email User 104, 124 since the Email User 104, 124 no longer has to go and delete the transmitted email from the sent email folder.

Multiple variations and modification to the disclosed embodiments will occur, to the extent not mutually exclusive, to those skilled in the art upon consideration of the foregoing description. For example, not all steps are required to be performed in the order disclosed and in fact some steps may be skipped altogether in certain embodiments of the invention. Such variations and modifications, however, fall well within the scope of the present invention as set forth in the following claims.

What is claimed is:

1. A method for organizing emails in folders, comprising the steps of:
a) preparing an email for transmittal;
b) choosing a folder; and
c) selecting a send/file option thereby causing:
i) the email to be transmitted to at least one recipient,
ii) the email to be stored in the chosen folder, and
iii) the email is either not stored in a sent email folder or is deleted from the sent email folder.

2. The method of claim 1, wherein the folder is chosen by an Email User from a plurality of folders displayed on a web page.

3. The method of claim 1, wherein the folder is chosen by an email system from a plurality of folders based at least in part on the subject matter of the email and a subject matter attributed to the chosen folder.

4. The method of claim 1, wherein the folder is chosen by an email system from a plurality of folders based at least in part on words in the email and key words attributed to the chosen folder.

5. The method of claim 1, wherein the folder is chosen by an email system from a plurality of folders based on a recipient listed in the email and a recipient name attributed to the folder.

6. The method of claim 1, wherein the chosen folder is associated with a Web-based email account.

7. The method of claim 1, wherein the chosen folder is associated with a Client-based email application.

8. A method for organizing emails in folders, comprising the steps of:
a) receiving an original email;
b) selecting an option to reply to the received original email;
c) preparing a reply email for transmittal;
d) choosing a folder; and
e) selecting a send/file option thereby causing:
i) the reply email to be transmitted,
ii) the original email to be stored in the chosen folder, and
iii) the reply email is either not stored in a sent email folder or is deleted from the sent email folder.

9. The method of claim 8, wherein the folder is chosen by an Email User.

10. The method of claim 8, wherein the folder is chosen by an email system from a plurality of folders based at least in part on words used in the original email or the reply email.

11. The method of claim 8, wherein the folder is chosen by an email system from a plurality of folders based on a recipient of the reply email.

12. The method of claim 8, wherein the chosen folder is associated with a Web-based email account.

13. The method of claim 8, wherein the chosen folder is associated with a Client-based email application.

14. The method of claim 8 further comprising the step of:
f) prior to step e), selecting an option to store the original email in the chosen folder.

15. A method for organizing emails in folders, comprising the steps of:
a) receiving an original email;
b) selecting an option to reply to the received original email;
c) preparing a reply email for transmittal;
d) choosing a folder; and
e) selecting a send/file option thereby causing:
i) the reply email to be transmitted to a recipient,
ii) the reply email to be stored in the chosen folder, and
iii) the reply email is either not stored in a sent email folder or is deleted from the sent email folder.

16. The method of claim 15, wherein the folder is chosen by an Email User.

17. The method of claim 15, wherein the folder is chosen by an email system from a plurality of folders based at least in part on words used in the original email or the reply email.

18. The method of claim 15, wherein the folder is chosen by an email system from a plurality of folders based on a recipient of the reply email.

19. The method of claim 15, wherein the chosen folder is associated with a Web-based email account.

20. The method of claim 15, wherein the chosen folder is associated with a Client-based email application.

21. The method of claim 15 further comprising the step of:
f) prior to step e), selecting an option to store the reply email in the chosen folder.
